(19) United States
(12) Patent Application Publication
(10) Pub. No.: US 2005/0168629 A1
(43) Pub. Date: Aug. 4, 2005

(54) Microcamera

(75) Inventors: Eiji Togawa, Nagoya (JP); Shuntaro Hayashi, Chita (JP)

Correspondence Address: Koda & Androlia, 2029 Century Park East, Suite 1140, Los Angeles, CA, 90067-2912, US

(73) Assignee: Elmo Co., Ltd.

(21) Appl. No.: 10/867,234

(22) Filed: Jun. 14, 2004

(30) Foreign Application Priority Data
Feb. 3, 2004 (JP) 2004-26377

(51) Int. Cl. H04N 5/225

(52) U.S. Cl. 348/375

(57) ABSTRACT

A microcamera includes a circuit board assembly including a circuit board on which electronic components and a control circuit are mounted and an electrical connector attached to the circuit board, a camera head assembly including a lens group, a CCD and a liquid crystal filter all of which are attached to a connecting holder, the circuit board assembly and the camera head assembly being separably coupled to each other with the coupling holder being interposed therebetween, a cylindrical housing having one end through which the coupled assemblies are inserted and the other end to which the circuit board assembly is fixed, and a camera head cap detachably attached to the camera head assembly projecting from said other end of the housing so as to cover the camera head assembly.

### BACKGROUND OF THE INVENTION

1. Field of the Invention

This invention relates to a microcamera using a CCD.

2. Description of the Related Art

A microcamera using a CCD includes an integral type and a connecting type. The microcamera of the integral type comprises a circuit board assembly including a circuit board on which electronic components and a control circuit are mounted and an electrical connector attached to the circuit board. The integral type microcamera further comprises a camera head assembly including lenses, a charge coupled device (CCD), a liquid crystal filter and the like all of which are mounted to a connecting holder. The circuit board assembly and the camera head assembly are integrated and then inserted into a cylindrical housing. On the other hand, in the connecting type, the circuit board assembly and the camera head assembly discrete from each other are inserted through respective ends of the cylindrical housing and connected to each other in the cylindrical housing.

The integral type microcamera is easy to assemble and accordingly has a good working efficiency since the circuit board assembly and the camera head assembly are integral. However, integration requires use of resin components and accordingly, the integral type microcamera has a difficulty in ensuring a mounting precision of the CCD. Furthermore, when the CCD and/or the liquid crystal has a defect, the integrated components are taken out of the housing and the CCD and the liquid crystal filter need to be removed from the integrated components before inspection and repair. Thus, the inspection and repair are troublesome. Accordingly, the integral type microcamera has problems in its maintenance.

In the connecting type microcamera, the camera head assembly is connected via a connector to the circuit board assembly mounted to the other end of the housing. As a result, an assembling efficiency is lower in the connecting type microcamera than that in the integral type.

### SUMMARY OF THE INVENTION

Therefore, an object of the present invention is to provide a microcamera in which the working efficiency can be improved in the adjustment and/or maintenance of the CCD and liquid crystal filter.

The present invention provides a microcamera comprising a circuit board assembly including a circuit board on which electronic components and a control circuit are mounted and an electrical connector attached to the circuit board, a camera head assembly including a lens group, a CCD and a liquid crystal filter all of which are attached to a connecting holder, the circuit board assembly and the camera head assembly being separably connected to each other with the connecting holder being interposed therebetween, a cylindrical housing having one end through which a combination of the assemblies is inserted and the other end to which the circuit board assembly is fixed, and a camera head cap detachably attached to the camera head assembly projecting from said other end of the housing so as to cover the camera head assembly.

In the above-described microcamera, the circuit board and camera head assemblies are separably connected together with the metal connecting holder being interposed therebetween. Accordingly, the combination can be inserted through one end of the cylindrical housing and assembled together. Further, the camera head assembly can be separated from the circuit board assembly when the camera head cap is detached from the other end of the cylindrical housing and the connecting holder of the camera head assembly protruding from the other end. Consequently, the working efficiency can be improved in the adjustment and maintenance of the CCD and liquid crystal filter. Additionally, a high precision can be ensured in the mounting of the CCD since the metal connecting holder is made by die-casting or by cutting.

### BRIEF DESCRIPTION OF THE DRAWINGS

Other objects, features and advantages of the present invention will become clear upon reviewing the following description of the embodiment with reference to the accompanying drawings, in which:

FIG. 1 is a perspective view of the microcamera in accordance with one embodiment of the present invention;

FIG. 2 is a perspective view of the circuit board assembly and the camera head assembly both connected together;

FIG. 3 is a perspective view of the connecting holder;

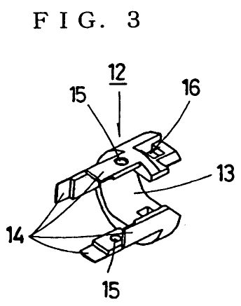

FIG. 4 is a perspective view of the combination of the circuit board and camera head assemblies inserted into the cylindrical housing; and

FIG. 5 is a perspective view of the camera head cap and the camera head assembly both detached from the cylindrical housing.

### DETAILED DESCRIPTION OF THE INVENTION

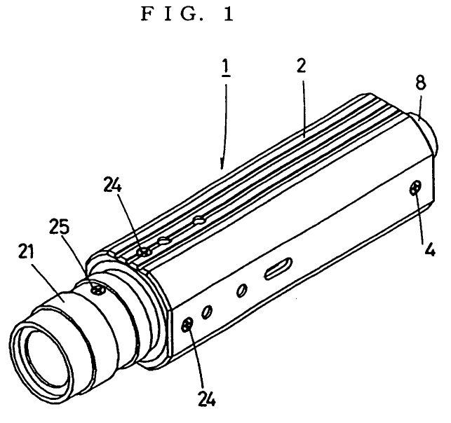

One embodiment of the present invention will be described with reference to the accompanying drawings. Referring to FIG. 1, a microcamera 1 in accordance with the embodiment of the invention is shown. The microcamera 1 includes a generally cylindrical housing 2. A combination 19 of a circuit board assembly 3 and a camera head assembly 11 is inserted into the cylindrical housing 2 to be fastened by a machine screw 4 to the housing. The camera head assembly 11 will be described later. The circuit board assembly 3 includes a circuit board 5 on which an electronic component 6, a control circuit 7 and the like are mounted. An electrical connector 8 and the like are attached to the rear of the circuit board 5. The circuit board assembly 3 has a distal end from which a pair of engagement claws 9 protrude. The engagement claws 9 are adapted to be engaged with a pair of engagement recesses 16 respectively so that a connecting holder 12 which will be described later is connected to the circuit board assembly 3.

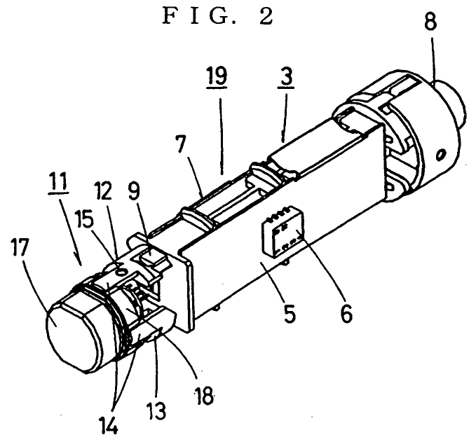

The camera head assembly 11 is connected via the connecting holder 12 to the distal end of the circuit board assembly 3 as shown in FIG. 2. The connecting holder 12 is die-cast from a metal or made by cutting a metal. The connecting holder 12 includes an imperfectly circular cylindrical body 13 from which four holding arms 14 protrude. Each holding arm 14 is formed with a screw hole 15. The body 13 of the connecting holder 12 has the engagement recesses 16 which are engaged with the aforesaid engagement claws 9 formed on the distal end of the circuit board assembly 3, respectively. The camera head assembly 11 includes a liquid crystal filter 17 and a CCD 18 both held by the holding arms 14 of the connecting holder 12.

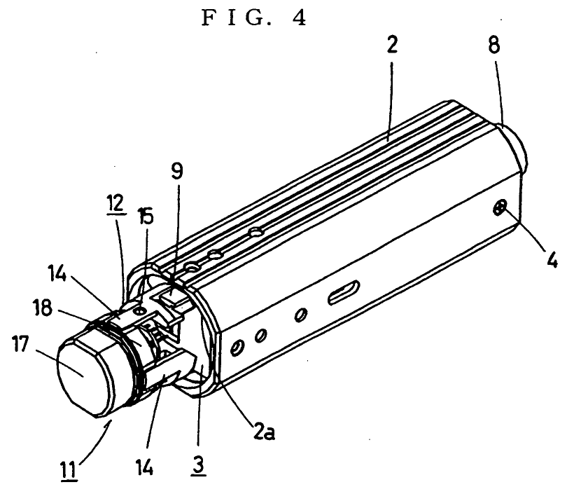

The engagement claws 9 of the circuit board assembly 3 are engaged with the engagement recesses 16 of the connecting holder 12 respectively so that the circuit board assembly 3 and the camera head assembly 11 are detachably coupled with each other. The combination 19 of the circuit board and camera head assemblies is inserted into a rear end opening of the cylindrical housing 2 and the camera head assembly 11 is caused to protrude from the distal end opening 2a of the cylindrical housing. The connector 8 of the circuit board assembly 3 is fastened to the cylindrical housing 2 by the machine screw 4 as shown in FIG. 4.

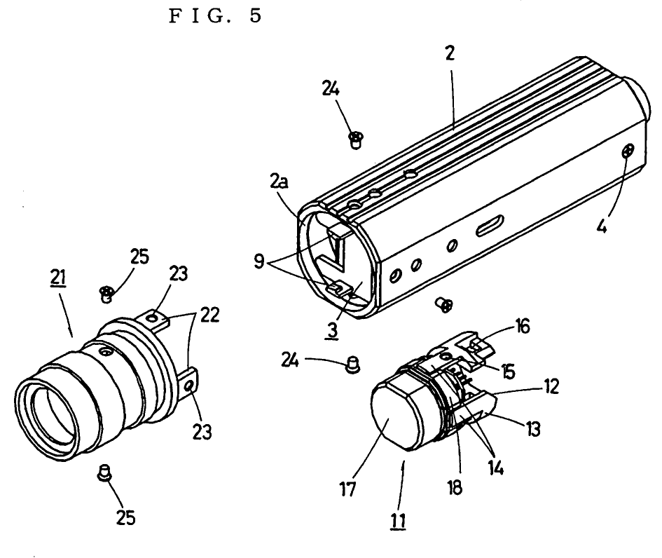

A camera head cap 21 is attached to the camera head assembly 11 protruding from the distal end opening 2a. The camera head cap 21 has a rear end from which a plurality of connecting strips 22 formed with respective screw holes 23 protrude rearward, as shown in FIG. 5. The connecting strips 22 are inserted into the distal end opening 2a. A plurality of machines crews 24 are screwed through screw holes of the cylindrical housing 2 into the screw holes 23 respectively so that the camera head cap 21 is mounted to the cylindrical housing 2. Further, two machine screws 25 are screwed through screw holes formed in the camera head cap 21 into the screw holes 15 of the holding arms 14 respectively so that the camera head cap 21 is fastened to the holding arms 14.

In the microcamera 1 having the above-described construction, the circuit board and camera head assemblies 3 and 11 are separably connected to each other with the metal connecting holder 12 being interposed therebetween. Accordingly, the combination 19 of the coupled assemblies 3 and 11 can be inserted through the rear end opening of the cylindrical housing 2 and assembled together.

Further, only the camera head assembly 11 can be separated from the circuit board assembly 3 when the camera head cap 21 is detached from the distal end opening 2b of the cylindrical housing 2 and the engagement claws 9 are disengaged from the engagement recesses 16 of the connecting holder 12 of the camera head assembly 11 protruding from the distal end opening 2b. Consequently, the working efficiency can be improved in the adjustment and maintenance of the liquid crystal filter 17 and the CCD 18. Additionally, a high precision can be ensured in the mounting of the CCD 18 since the metal connecting holder 12 is made by die-casting or by cutting.

Furthermore, the circuit board assembly 3 is fixed to the cylindrical housing 2 by the machine screws. The camera head cap 21 is also fixed to the connecting holder 12 by the machine screws. The assemblies and components can easily be connected together and separated from each other.

The foregoing description and drawings are merely illustrative of the principles of the present invention and are not to be construed in a limiting sense. Various changes and modifications will become apparent to those of ordinary skill in the art. All such changes and modifications are seen to fall within the scope of the invention as defined by the appended claims.

1. A microcamera comprising:
a circuit board assembly including a circuit board on which electronic components and a control circuit are mounted and an electrical connector attached to the circuit board;
a camera head assembly including a lens group, a CCD and a liquid crystal filter all of which are attached to a connecting holder, the circuit board assembly and the camera head assembly being separably coupled to each other with the coupling holder being interposed therebetween;
a cylindrical housing having one end through which the coupled assemblies are inserted and the other end to which the circuit board assembly is fixed; and
a camera head cap detachably attached to the camera head assembly projecting from said other end of the housing so as to cover the camera head assembly.

2. A microcamera according to claim 1, wherein the circuit board assembly has a distal end formed with an engagement claw protruding the distal end and the connecting holder has an engagement recess, the engagement claw and the engagement recess being engaged with each other so that circuit board assembly and the camera head assembly are connected to each other.

3. A microcamera according to claim 1, wherein the metal connecting holder is made by die-casting or cutting.

4. A microcamera according to claim 2, wherein the metal connecting holder is made by die-casting or cutting.

5. A microcamera according to claim 1, wherein the circuit board assembly is fastened by a machine screw to the cylindrical housing thereby to be fixed-to the cylindrical housing, and the camera head assembly is also fastened by a machine screw to the connecting holder thereby to be fixed to the connecting holder.

6. A microcamera according to claim 2, wherein the circuit board assembly is fastened by a machine screw to the cylindrical housing thereby to be fixed to the cylindrical housing, and the camera head assembly is also fastened by a machine screw to the connecting holder thereby to be fixed to the connecting holder.

7. A microcamera according to claim 3, wherein the circuit board assembly is fastened by a machine screw to the cylindrical housing thereby to be fixed to the cylindrical housing, and the camera head assembly is also fastened by a machine screw to the connecting holder thereby to be fixed to the connecting holder.

8. A microcamera according to claim 4, wherein the circuit board assembly is fastened by a machine screw to the cylindrical housing thereby to be fixed to the cylindrical housing, and the camera head assembly is also fastened by a machine screw to the connecting holder thereby to be fixed to the connecting holder.
